(19) United States
(12) Patent Application Publication
(10) Pub. No.: US 2005/0143875 A1
(43) Pub. Date: Jun. 30, 2005

(54) Electromechanical control system, particularly for marine applications

(76) Inventor: Giorgio Gai, Busalla (IT)

Correspondence Address: James C. Wray, Suite 300, 1493 Chain Bridge Road, McLean, VA, 22101, US

(21) Appl. No.: 10/987,216

(22) Filed: Nov. 15, 2004

(30) Foreign Application Priority Data
Nov. 14, 2003 (IT) SV2003A000046

(51) Int. Cl. G06F 17/00

(52) U.S. Cl. 701/21; 114/144 RE

(57) ABSTRACT

An electromechanical control system for watercrafts, motorboats, ships or the like, having at least: a control station, an engine, an electromechanical actuator associated to said engine, a signal transmission device for transmitting a control signal generated by the control station to an electronic control and monitoring unit, and further having a signal transmission device for transmitting an actuating signal, generated by the electronic control and monitoring unit as a function of the control signal and transmitted to said electromechanical actuator for actuating the control, characterized in that said electronic control and monitoring unit establishes a unique correspondence between the control signal and the actuating signal by using a table of corresponding discretized values of control signals and actuating signals and/or by determining the actuating signal value from the control signal by means of a mathematical function.

The present invention relates to an electromechanical control system for watercrafts, motorboats, ships or the like, having at least: a control station, an engine, an electromechanical actuator associated to said engine, a signal transmission device for transmitting a control signal generated by the control station to an electronic control and monitoring unit, and further having a signal transmission device for transmitting an actuating signal, generated by the electronic control and monitoring unit as a function of the control signal and transmitted to said electromechanical actuator for actuating the control.

Such apparatuses are well known in the art and widely used. While these apparatuses satisfactorily serve their function, they still suffer from certain drawbacks.

It is known that a control signal set by the user from the control device, e.g. a control lever, which control device allows a mechanical or electromechanical control, for instance, of the throttle or a fuel flow meter device for controlling flow to the watercraft engine, causes the throttle to open and a higher flow of fuel to reach the engine. The greater fuel flow causes the engine to increase the number of its operating revolutions per minute and, as a result, its power. Nevertheless, those skilled in the art are aware that the opening of the throttle and/or the increased fuel flow generated by the flow meter device, causing a corresponding increase of the engine's rpm, does not linearly correspond to an increase of the power delivered by the engine, because no linear relationship exists between power and fuel delivery in the equation that regulates engine operation. Particularly, their relationship is of the nonlinear type and differs from linearity especially in multiple cylinder gasoline and diesel engines.

Due to this nonlinearity, a control corresponding for instance to 50% of the maximum control lever range, does not cause a proportional 50% increase of the delivered power, which may be higher or lower depending, as mentioned above, on additional parameters, such as the number of revolutions at which the throttle opens.

Hence, the angular displacement of the control lever may lead to an increase of the delivered power that may considerably differ from one situation to the other, and this may affect an easy control of the watercraft.

This drawback is particularly felt when the watercraft driving conditions must be fast and accurate, for instance in mooring or harbor maneuvers, where an unexpected power increase might have undesired consequences, such as an impact against the quay or other moored vessels. Also, this problem is particularly felt with small watercrafts, whose pilots sometimes do not have sufficient expertise to control a watercraft in case of a sudden speed increase caused by an increase of the power delivered by the engine, which is controlled by the pilot through the control lever, which engine, as mentioned above, does not react linearly to the displacement of the control lever.

In prior art, the delivered power may be controlled while maneuvering, but at the maximum angular displacement of the control lever it does not correspond to the maximum fuel flow delivered by the flow meter device and/or by the throttle. This kind of control is simple but poorly effective, as the relationship between the displacement of the control lever and the opening of the throttle and/or flow meter device is still linear, which causes a non linearity of the power delivered to the engine, for the above reasons. Hence, the above problems are not solved by prior art, which only reduces the maximum opening of the throttle, to allow the user to have an easier, but not optimized control of the watercraft.

Furthermore, in prior art arrangements, nonlinear power delivery cause problems not only during maneuvers, but also in offshore navigation; it may be easily understood that serious problems may arise whenever a total control of the watercraft is needed, such as when other vessels are encountered, in rough sea conditions, or the like.

Furthermore, in addition to not being able to linearize the delivered power by displacing the control lever, prior art system do not even allow to set a different acceleration “profile”. Such different profile may be useful when the user decides to use a personal drive style, an up to 50% control lever displacement involving a power increase of up to 30% of the maximum power, and a 50% to 100% control lever displacement involving a power increase of 30% to 100%, or less, of the maximum deliverable power. Such an exemplified customized delivering arrangement provides a very smooth control of the watercraft at low speeds, which is particularly useful in coastwise navigation, where other vessels, swimmers or divers are very likely to be encountered. Also, the normal delivery obtained in prior art systems does not allow to configure the maximum opening that may be reached by the throttle and/or the maximum fuel flow delivered by the fuel flow meter device, at the maximum control lever displacement, with a variable profile. Thus, prior art systems do not allow to set the delivery in “power saving” drive conditions, in which the throttle has an 80% maximum opening, allowing to save fuel and reduce the wear of the engine.

The nonlinearity between the control set by the control lever and the delivered power in prior art systems further involves a number of other drawbacks, associated for instance to the difficulties encountered by inexperienced pilots of watercrafts: an inexpert user may easily make evaluation errors, and as a consequence, driving errors, which may lead to unexpected consequences; consider, for instance, a user who is learning how to drive, and during a narrow turn, inadvertently displaces the control lever and causes a sudden and unexpected engine power increase. Due to such errors, an inexperienced user may lose the control of the watercraft, which may lead to easily guessable consequences.

Furthermore, in prior art systems, where the signal of the control station associated to the control lever is transmitted to an electromechanical actuator which is designed to control the throttle and/or a fuel and/or fuel-air mixture flow meter device, there is no system for checking proper transmission of the control signal and for making an action, when needed, to prevent any drawback deriving from an improper signal transmission. Consider, for instance, a system in which the wrong control signal is transmitted as it is to the actuator; this involves a considerable danger, as a wrong maximum control lever displacement signal during a maneuver in narrow spaces leads to a number of problems, such as collisions of considerable importance. Also, when no communication exists between the control station and the actuator, in prior art apparatuses the actuator signal is kept unchanged, which may also lead to considerable drawbacks, both during harbor maneuvers and during free navigation when other vessels, swimmers, divers or obstacles are encountered, and the lack of communication prevents any deceleration or reversing maneuvers.

Prior art apparatuses further have a drawback which is associated to the fact that, when the direction of the propeller rotation is reversed, by a backward displacement of the control lever, the opening of the throttle is linear with the backward displacement of the control lever, whereby the user who has to deal with the above discussed nonlinear delivery, is subjected to the same drawbacks as mentioned above, and to the additional problem that the watercraft is, for instance, moving astern, and is difficult to maneuver.

The object of the present invention is to provide an electromechanical control system, particularly for marine applications, according to the preamble of claim 1, which may simply and inexpensively obviate the drawbacks of prior art electromechanical control systems, particularly for marine applications.

The invention fulfils the above objects by providing an electromechanical control system for watercrafts, motorboats, ships or the like, having at least: a control station, an engine, an electromechanical actuator associated to said engine, a signal transmission device for transmitting a control signal generated by the control station to an electronic control and monitoring unit as a function of the control signal and transmitted to said electromechanical actuator for actuating the signal, and further having a signal transmission device for transmitting an actuating signal, generated by the electronic control and monitoring unit as a function of the control signal and transmitted to said electromechanical actuator for actuating the control, characterized in that said electronic control and monitoring unit establishes a unique correspondence between the control signal and the actuating signal by using a table of correspondence between discretized values of control signals and actuating signals and/or by determining the actuating signal value from the control signal by means of a mathematical function.

In a preferred arrangement, the invention includes a control station associated to a control device for the user to set a control signal, said control setting device being able to be displaced relative to a fixed reference, its displacement being related to a control signal value, with electric, electronic and/or electromechanical means being associated to said control device, for detecting the displacement of the control device and for generating a control signal that is uniquely related with said displacement. In a preferred arrangement, the control device is provided in the form of a lever that pivots about a fulcrum, having known systems for electric/electronic detection of the angular displacement (BETA) of the lever, which is turned into an electric/electronic control signal. Such control signal is transmitted to the programmable electronic control and monitoring unit through said signal transmission devices in the form of a CAN BUS. The electronic control and monitoring unit stores one or more tables of unique correlation between the control signal corresponding to the angular position (BETA) of the control lever and the actuating signal corresponding to the angular position (ALFA) of the actuating lever and/or the flow meter or control device. Alternatively, according to an alternative preferred embodiment, the electronic control unit stores, in the form of a program code to be executed thereby, one or more different functions of unique correlation between the control signal corresponding to the angular position (BETA) of the control lever and the actuating signal corresponding to the angular position (ALFA) of the actuating lever and/or the flow meter or control device, the corresponding actuating signal being determined from time to time, for each control signal, by using one of said correlation functions.

The actuating signal so generated by the electronic control and monitoring unit is transmitted by the electronic control and monitoring unit to said actuator through the signal transmission devices, preferably in the form of a CAN bus. The actuator has a pivoting actuating lever which acts on the device for delivering fuel and/or fuel-air mixture of/to the engine and/or on a flow meter or control device having a flow metering or controlling member that can be angularly displaced about a predetermined axis, which lever and/or which flow meter or control device take a predetermined angular position (ALFA) relative to a stationary reference, as a function of the angular position (BETA) of the control lever relative to the corresponding stationary reference.

In a further preferred embodiment, the device for delivering fuel and/or air-fuel mixture of/to the engine and/or the flow meter or control device having a flow metering or controlling member are a throttle which controls the fuel flow and flow rate; in this case, the mathematical correspondence functions associated to the electronic control and monitoring unit establish such a unique correspondence between the control signal and the actuating signal that ALFA=f(BETA), where BETA is the control lever displacement angle and ALFA is the throttle opening angle and where f is any mathematical function having BETA as a variable.

A memory may be preferably associated to said electronic control unit, preferably a nonvolatile memory, and means for loading in such memory one or more correlation functions f(BETA) and/or tables of correspondence between the angle of the actuating lever and/or of the flow meter or control device and/or of a throttle (ALFA) and the angle (BETA) of a control lever.

The mathematical function f(BETA) is such that, given an angular displacement BETA, the displacement angle ALFA is determined as a result of the computation, by entering the BETA value in the function. Thus, the angular displacement of the control lever may be physically linked to the angular displacement of the throttle controlling lever even in a nonlinear manner, for instance according to a parabolic or hyperbolic function or a mathematical rule which produces any function whatever. Hence, the actual result of the invention is that the throttle opening may be perfectly programmable as a function of the control lever displacement angle.

Alternatively, preset tables of correspondence may be used, which may be loaded into the memory of the electronic control and monitoring unit, to make any correspondence whatever between BETA and ALFA, by associating any BETA value to a corresponding ALFA value, while possibly providing a linear interpolation between the preset values.

The operation of the inventive system is as follows: the user actuates the control device, e.g. the control lever, and the control signal so generated, i.e. the angular displacement BETA of the control lever is received by usual electric, electronic or electromechanical systems and is preferably digitized and transmitted through a CAN bus to the electronic control and monitoring unit. The electronic control and monitoring unit computes the preset function and provides, as a result of such computation, a control signal to be transferred, still preferably through a CAN bus, to the actuator, which accordingly actuates the fuel flow meter or control device and/or the throttle of the engine. By this arrangement, the displacement of the control lever may trigger any power response engine, possibly a nonlinear response.

In accordance with an alternative embodiment, at least one table of correspondence between the control signal value BETA and the actuating signal value ALFA is stored in a preferably nonvolatile memory of the electronic control and monitoring unit. Hence, the actuating signal is generated by a comparison in the table of correspondence by entering the BETA value therein. The BETA value and the corresponding ALFA value may be further freely interpolated between two predetermined values when they have not been previously stored in the electronic control and monitoring unit.

In a preferred variant embodiment, a variety of mathematical functions may be stored in the nonvolatile memory associated to said electronic control unit, and the setting, i.e. the selection of the mathematical function or the table of correspondence is preferably effected by using selectors, whose various combinations correspond to different mathematical functions and/or tables of correspondence which relate ALFA and BETA. These selectors are preferably a set of DIP switches. A certain number of combinations of switching conditions of the switches of the set is uniquely related as a selection code with one of the various correlation functions f (BETA) or a different table of correspondence, furthermore each switching combination of the set of DIP switches provides a control to load said corresponding correlation function or correlation table in the working storage of the control electronics. The memory of the electronic control and monitoring unit may be further adapted to be reprogrammed several times. Therefore, the user may select beforehand a desired kind of drive by setting the correspondence between ALFA and BETA given by the different functions, which corresponds to a different power response behavior of the engine, hence a different behavior of the watercraft.

The user decides the desired function and/or table of correspondence by selecting an appropriate combination of DIP switches, hence the table and/or the function will be loaded by the electronic control and monitoring unit in the working storage.

Amongst the various functions, a predetermined function, for instance, may be provided and programmed for maneuvering, in which, while providing a perfect linearity between the angular displacement of the control lever and the delivered power, the maximum delivered power may be arranged to be 30% of the maximum power delivered by the engine. This allows to obviate prior art problems associated to nonlinear power delivery, which affect the ease of drive.

Also, a function ALFA=f(BETA) may be preset, whose result is to obtain, providing a maximum power of 100% of the maximum deliverable power, a curve of power delivery that is linear with the displacement of the control lever, so that the maximum power is by no way reduced, but in such a manner as to provide an easier drive and a better control of the watercraft, while actually preventing any drive errors associated to a sudden acceleration of the watercraft caused by an unexpected engine power increase, like in the above discussed prior art.

A “power saving” drive function might be further programmed in the electronic control unit, which corresponds, for instance, to a maximum throttle opening equal to 80% of the maximum opening, or equal to 80% of the maximum deliverable power, and a user selected profile may be provided, to allow a power saving drive, with consequent fuel savings, a lower engine wear, and an effective control of the delivered power.

Thus, this invention allows to program and set several different watercraft acceleration profiles, to configure a wholly customized watercraft drive, which may be hence adapted to a number of different requirements. For example, a function may be programmed and set whereby a 50% displacement of the control lever involves a linear increase of the delivered power of up to 30% of the maximum power, and a 50% to 100% displacement of the control lever involves a power increase of 30% to 100%, or less, of the maximum deliverable power. Such delivering arrangement provides a very smooth control of the watercraft at low speeds, which is particularly useful in coastwise navigation, where other vessels, swimmers or divers are very likely to be encountered and where an accurate control of the watercraft is imperative.

This also allows to obviate prior art drawbacks associated to a possible sudden increase of the delivered power during a narrow turn; thanks to the linearity between the control lever displacement and the delivered power, the user is not exposed to such danger, unless such power increase is caused by a voluntary excessive displacement of control lever.

Also, according to this invention, several functions f′ (BETA) may be programmed and set, exactly like the functions f(BETA), to be used when the displacement of the control lever has a negative value. Assuming that the central control lever position corresponds to a situation of no delivery and to a minimum throttle opening, typically in watercrafts, a fore displacement of the control lever causes a forward motion of the watercraft, due to the actuator-controlled opening of the throttle, whereas an aft displacement of the control lever triggers an inverter, which drives the propeller in reverse rotation, so that the watercraft is pushed backwards due to the reverse rotation of the propeller and to the opening of the throttle. Here, the angular displacement BETA of the control lever is negative. This negative displacement may be associated, thanks to the electronic control and monitoring unit of this invention, to a function f′ (BETA) that is different from f(BETA), for instance programmed in such a manner that the reversing maneuver of the watercraft is facilitated, with an enhanced linearity in the first portion of the control lever range and a maximum deliverable power of less than 100%. The drive is thus dramatically facilitated as compared with prior art systems, in which the acceleration of the watercraft in reverse motion was essentially equal to forward motion acceleration.

According to a preferred embodiment of the invention, the electronic control and monitoring unit may be designed to monitor signal transmission from the control station to the throttle actuator. This allows to overcome the above mentioned prior art problems associated to a lack of the monitoring capability. According to the present invention, the electronic control and monitoring unit monitors the communication and, when a wrong signal or a lack of signal is detected in the control station, the electronic control unit brings the throttle controlling lever in the minimum opening condition, and the inverter is brought in the neutral position, while the user receives an error warning by optical and/or acoustic signals. The throttle controlling lever remains in the minimum opening condition and the inverter remains in the neutral position until the error is acknowledged by the electronic control and monitoring unit and/or the user possibly selects a different control station.

This allows to obviate the prior art problems associated, for example, to a system in which the wrong control signal is transmitted as it is to the actuator, involving a considerable danger, as a wrong maximum control lever displacement signal during a maneuver in narrow spaces leads to a number of problems, such as collisions of considerable importance, which problems are avoided by using a device according to this invention. Also, when no communication exists between the control station and the actuator, in prior art apparatuses the actuator signal is kept unchanged, which may also lead to considerable drawbacks, both during harbor maneuvers and during free navigation when other vessels, swimmers, divers or obstacles are encountered, and the lack of communication prevents any deceleration or reversing maneuvers whereas, according to this invention, no thrust is exerted on the watercraft by the engine, and the user is immediately warned thereof and has the time to take over control of the watercraft and avoids any drawback deriving from a lack of communication or a wrong communication between the control station and the actuator.

In an additional preferred application, this invention provides the use of multiple control stations, each with one or more control levers. Here, there may be provided as many control and monitoring electronic units as actuators, with exactly the same operation as discussed above. Alternatively, due to cost and space saving reasons, there may be provided a single control and monitoring electronic unit, for the management of all communications and all control signals set on the different control levers and on the corresponding actuators. In this case, the control stations are typically equipped with a toggle switch, which is controlled by the user to inform the electronic control and monitoring unit about the user selected control station to drive the watercraft. Hence, the control and monitoring electronic unit which receives the angular control lever displacement signal BETA from the selected control station, processes the signal as described above for a single station, and computes the displacement ALFA of the throttle controlling actuator lever by the function f(BETA).

If a single control and monitoring electronic unit is provided, this may provide a number of different functions f(BETA) associated to the different control levers, particularly a specific control lever may be associated to the function f(BETA) used for harbor maneuvers, and a different control station is associated to a function f(BETA) used, for instance, for power saving navigation, as described above. Nevertheless, the various stations may be associated either to the same or different functions f(BETA), so that the watercraft may be easily and flexibly driven, to meet different user requirements.

In the latter case, which provides a single control and monitoring electronic unit, the latter may be also used for the above mentioned control signal transmission checking function.

In accordance with another characteristic, the table of correspondence may be advantageously formed as follows: all predetermined BETA values may be first entered, to determine the corresponding ALFA values, otherwise only some BETA and ALFA values are entered, in which case the omitted intermediate values are determined by the electronic control and monitoring unit by an interpolation, which may be a linear, a least-squares interpolation or any other type of interpolation, other than the ones mentioned above.

Hence, when the user moves the control lever through a given angle BETA, the displacement value is detected by the control electronic unit, which compares it with the value in the table of correspondence. If the BETA value is equal to a previously set value, the corresponding ALFA value is directly read from the table. Conversely, if the BETA value is somewhere between two different set values, without corresponding to none of them, the electronic control and monitoring unit interpolates the value in any manner to provide the interpolated ALFA value.

Moreover, according to a preferred embodiment, the above table of correspondence may be set either into a nonvolatile memory, and selected by using the DIP-SWITCHES as described above, or directly through special devices in the control station during use. This allows the user the set BETA and ALFA values before, during or after operation, directly from the control station, by selecting a control configuration e.g. adapted to sea conditions, thereby making the inventive device even more flexible. Here, the control station may be associated to an input keypad through which said values may be entered.

The system of this invention may further provide a feedback to the control and monitoring electronic unit, particularly the engine speed, i.e. the number of revolutions made by the engine may be transmitted as a signal to the control unit which, in a preferred embodiment, may use such number of revolutions to appropriately set the ALFA value and/or to check for any abnormalities or errors in the system. For example, the displacement value ALFA may have to correspond to a given engine rpm value and, thanks to such feedback, the electronic control and monitoring unit might check the compliance with this value and the proper transmission of the control signal to the actuator. It may be easily understood for instance that, assuming a 10% throttle opening, the engine rpm cannot and must not be close to the maximum speed. If this occurs, there is an apparent system error, and the feedback allows to detect this error and to take the precautionary measures described above. Also, thanks to the feedback of a signal from the engine and/or the actuator, such signal may be used by the electronic control and monitoring unit and/or by the control station to check and/or monitor and/or set the above values of the table of correspondence. Therefore, the operation may be as follows: the user sets a certain engine rpm and selects, through a combination of keys, a control lever displacement corresponding to the set rpm. Therefore, the electronic control and monitoring unit uses the feedback from the engine, i.e. its rpm, which is a function of the angular displacement ALFA, and through the control lever displacement BETA, it creates a table of correspondence as selected by the user.

An additional characteristic of the invention is that, in some preferred embodiments, the electronic control and monitoring unit stores the sequence of detected errors. As described above, the electronic control and monitoring unit detects any control system operation errors, warns the user thereof, and in some cases takes appropriate danger preventing measures. In a preferred embodiment, the electronic control and monitoring unit also associates a code to any detected error type, and stores the rate of occurrence of the error. Hence, the electronic control and monitoring equipment may monitor any error occurring in the system and the number of occurrences of such error. The electronic control and monitoring unit may also monitor any engine and actuator malfunctions, and once more associate a code to each error and/or malfunction. All errors and malfunctions are identified as such by the electronic control and monitoring unit substantially through two preferred arrangements: according to the first arrangement, known sensors are provided to check operation and to transmit a wrong operation signal to the electronic control and monitoring unit whenever an abnormality occurs in the subsystem wherewith they are associated. In the second arrangement, the electronic control and monitoring unit generates an operation history for the control system, the engine and its parts and the actuator, and for any other system or subsystem of the watercraft which is connected to the electronic control and monitoring unit to transmit an operation signal thereto. Thus, the electronic control and monitoring unit may compare the operation signal it receives from any watercraft subsystem to identify any abnormality, i.e. any signal that excessively differs from the history of identical signals that was previously generated by the above mentioned detection. The electronic control and monitoring unit may provide not only a list of the occurrences and types of malfunctions in the control system as such, but also a list of the occurrences and types or errors and malfunctions of the watercraft part under its control. Therefore, the result of said monitoring action by the electronic control and monitoring unit may be advantageously used for maintenance purposes. This result may be displayed and/or printed and/or electronically transmitted to the user or to the watercraft maintenance personnel and/or communicated in any other manner, whereby watercraft maintenance may be well targeted, hence more effective. It will be understood, for instance, that if the electronic control and monitoring unit detects several control signal transmission errors at the remote control station, then the remote control station ought to be first checked out and possibly repaired and/or serviced. Advantages of such monitoring are apparent in terms of reduction of both times and costs for maintenance and troubleshooting. The electronic control and monitoring unit may be further used for self-checking and for providing both the complete error code and occurrence list and the suggested preventive maintenance. To this end, a list of errors and occurrences, associated to the recommended preventive maintenance, might be entered in the electronic control and monitoring unit. The electronic control and monitoring unit checks the history of system and/or subsystem and/or engine and or actuator error and/or malfunction signals and then may be able to generate, by comparison, a preventive maintenance warning, which may be useful for the user and/or the maintenance personnel for maintenance purposes.

Further characteristics and improvements will form the subject of the claims appended hereto.

The characteristics of the invention and the advantages derived therefrom will be more apparent from the following detailed description of the detailed figures, in which:

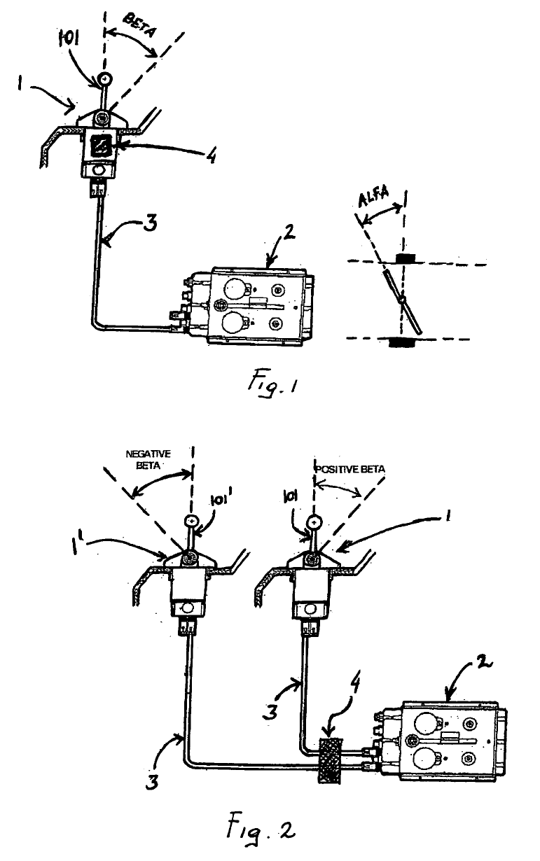

FIG. 1 shows a system according to this invention, which comprises one control station with one control lever and one actuator.

FIG. 2 shows a system according to this invention, which comprises two control stations with one control lever and one actuator.

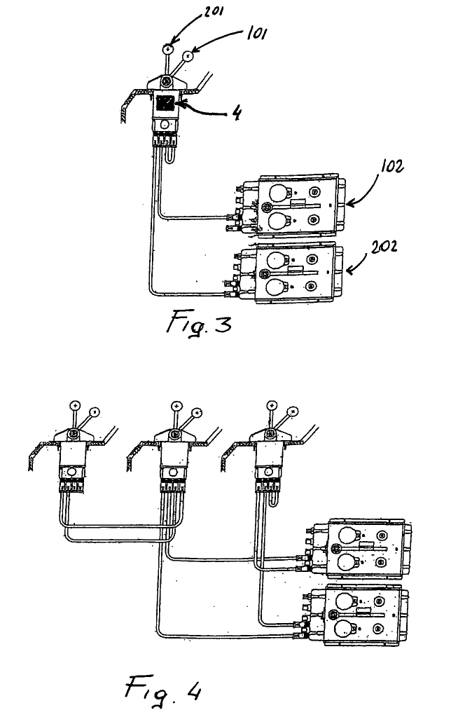

FIG. 3 shows a system according to this invention, which comprises one control station with two levers and two actuators.

FIG. 4 shows a system according to this invention, which comprises three control stations with two levers and two actuators.

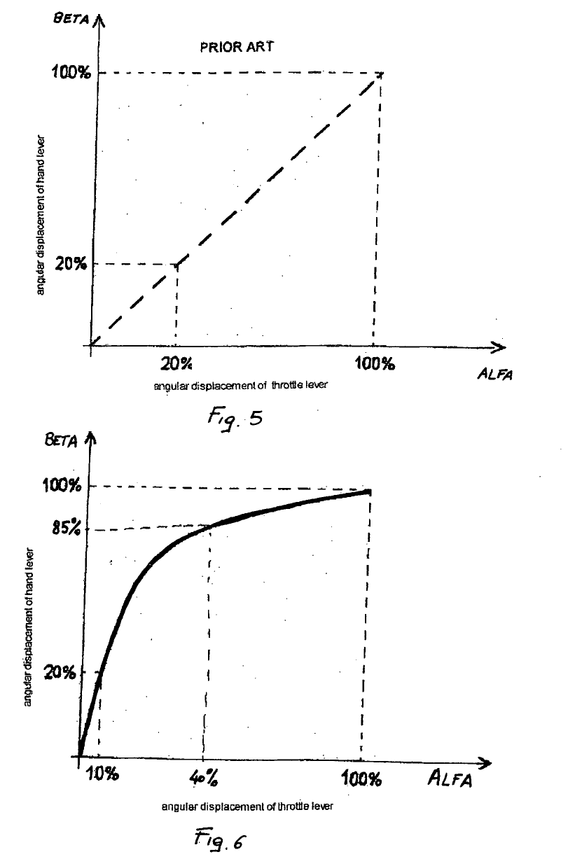

FIG. 5 is a diagram showing the relationship between the angular displacement of the control lever BETA and the angular displacement of the throttle lever ALFA according to prior art.

FIGS. 6, 7, 8 are diagrams showing the relationship between the angular displacement of the control lever BETA and the angular displacement of the throttle lever ALFA according to the present invention

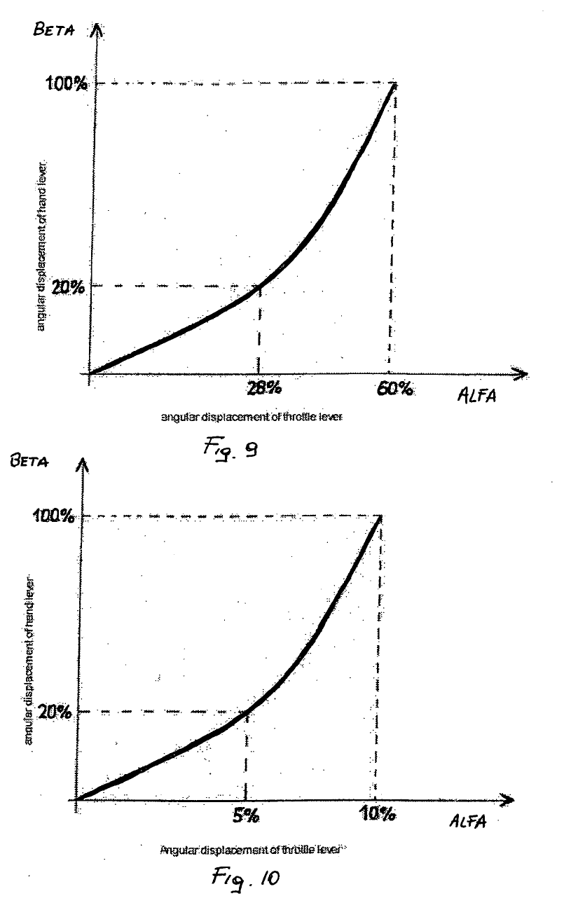

FIGS. 9 and 10 are diagrams showing the relationship between the angular displacement of the control lever BETA and the angular displacement of the throttle lever ALFA according to the present invention for a different case.

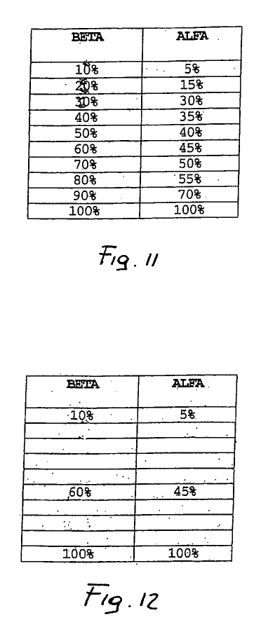

FIG. 11 is a general table of correspondence between BETA and ALFA values.

FIG. 12 is a general table of correspondence with only a few values therein for interpolation.

FIG. 1 shows the operatively simplest application, with one station including one control lever, which is associated to the electronic control and monitoring unit according to this invention. The control station 1 has a control device 101 for the user to set the control signal, said control setting device 101 being capable of being displaced relative to a stationary reference, such displacement being related to a value of the control signal. This control device is associated to electric, electronic and/or electromechanical means for detecting the displacement of the control device 101 and for generating a control signal that is uniquely correlated with said displacement. These means, which are part of the prior art, are not shown. Then, the control signal is transmitted to the electronic control and monitoring unit 4 through signal transmission devices that are coherent with the (electric, electronic, electromechanical) signal type generated by the control signal detection means. Preferably, the generated signal is of the electronic type and is transmitted to the electronic control and monitoring unit, and from the electronic control and monitoring unit to the actuator through a CAN BUS.

In FIG. 1, the control signal setting device is a control lever 101 which is capable of being angularly displaced (BETA) relative to a stationary reference, such as the fulcrum about which the lever pivots. Such pivotal displacement of the lever generates the control signal that acts on the device for delivering fuel and/or fuel-air mixture of/to the engine and/or on a flow meter or control device which has a flow metering or controlling member that can be angularly displaced about a predetermined axis. The lever and/or flow meter or control device take a predetermined angular position (ALFA) relative to a stationary reference as a function of the angular position (BETA) of the control lever relative to the corresponding stationary reference, thereby establishing a relationship between the control signal generated by the control lever and the characteristics of the fuel, and/or air-fuel flow delivered to the engine.

FIGS. 1 to 4 show the different applications of the invention. The invention may be implemented as shown in FIG. 1 to a system comprising one control station with one control lever and one actuator. This is certainly the simplest application, in which the angular displacement of the control lever 101 of the control station 1 is transmitted to the electronic control and monitoring unit 4 integrated in the control station 1 and is later transmitted through the CAN bus 3 to the actuator 2, which actuates, based on the signal, the lever and/or the flow meter or control device, and in a preferred embodiment the throttle actuating lever, not shown.

In a preferred embodiment, if BETA designates the displacement angle of the control lever that generates the input signal for the electronic control unit, and ALFA designates the throttle opening angle generated by the actuator by means of said lever, the control signal, i.e. the angular displacement BETA of the control lever is received by usual electric, electronic or electromechanical systems and is digitized and transmitted to the electronic control and monitoring unit 4, which computes the preset function and provides, as a result of such computation, a control signal which is transferred, still preferably through a CAN bus 3, to the actuator 2, which accordingly actuates the fuel throttle of the engine. By this arrangement, the displacement of the control lever 101 may provide a nonlinear throttle response.

In a preferred variant embodiment, a variety of mathematical functions may be stored into a nonvolatile memory associated to said electronic control unit 4, and the setting of the mathematical function or table of correspondence is preferably effected by using DIP switches, not shown, whose various combinations correspond to different mathematical functions and/or tables of correspondence (as shown in FIG. 11) linking ALFA and BETA. Therefore, the user may select beforehand a desired kind of drive by setting the correspondence between ALFA and BETA given by the different functions, which corresponds to a different power response behavior of the engine, hence a different behavior of the watercraft.

FIG. 2 shows a system according to this invention, which comprises two control stations 1 and 1′ having one control lever 101 and 101′ and one actuator 2. In this case, the electronic control and monitoring unit 4 is positioned downstream from the control stations and the control lever displacement signal BETA is transmitted to the electronic control and monitoring 4 through the CAN buses 3. Depending on the station selected by the user by means of a toggle switch on each control station 1 and 1′, the electronic control and monitoring unit processes, as described above, the BETA signal from the control station selected by the user by means of said toggle switch. Thus, the electronic control and monitoring unit 4 transmits the signal to the actuator 2, still through a CAN bus, as discussed above, and the actuator will open the throttle, by means of a control lever, through an angle ALFA. FIG. 2 further shows the POSITIVE BETA displacement of the control lever 101 and the NEGATIVE BETA displacement of the control lever 101′. Assuming that the central control lever position corresponds to a situation of no delivery and to a minimum throttle opening, typically in watercrafts, a fore displacement of the control lever, i.e. POSITIVE BETA, causes a forward motion of the watercraft, due to the actuator-controlled opening of the throttle, whereas an aft displacement of the control lever, i.e. NEGATIVE BETA, triggers an inverter, which drives the propeller in reverse rotation, so that the watercraft is pushed backwards due to the reverse rotation of the propeller and to the opening of the throttle. According to this invention, several functions f′ (BETA) may be programmed and set on the electronic control and monitoring unit 4, exactly like the functions f(BETA), to be used when the displacement of the control lever has a negative value. This negative displacement may be associated, thanks to the electronic control and monitoring unit 4 of this invention, to a function f′ (BETA) that is different from f(BETA), for instance programmed in such a manner that the reverse maneuver of the watercraft is facilitated, with an enhanced linearity in the first portion of the control lever range and a maximum deliverable power of less than 100%. The drive is thus dramatically facilitated as compared with prior art systems, in which the acceleration of the watercraft in reverse motion was essentially equal to forward motion acceleration.

Particularly a specific control lever 101′ may be associated to the function f(BETA) used for harbor maneuvers, whereas a different control lever 101 is associated to a function f(BETA) used, for instance, for power saving navigation. Nevertheless, the various stations may be associated either to the same or different functions f(BETA), so that the watercraft may be easily and flexibly driven, to meet different user requirements.

The electronic control and monitoring unit 4 may be further associated to a control station with two levers 101, 201, like in FIG. 3. Here, the electronic control and monitoring unit 4 allows to handle signals from said two control levers and transmits the signal, appropriately processed by f(BETA), to the two actuators, for instance to control two engines. In this case, the electronic control and monitoring unit 4 will receive two different input signals BETA1 and BETA2, from the two levers 101 and 201, and will transmit two different opening signals ALFAL and ALFA2 to the two actuators 102 and 202, and the control signals transmitted to the actuators will be determined by computation of the two mathematical relation functions f1 and f2, of the ALFAL=f1(BETA1) and ALFA2=f2(BETA2) type, as described above. It will be understood that the two functions may be identical or different, depending on programming and on user-selected DIP switch setting.

FIG. 4 shows a system according to the present invention, which comprises three control stations with two levers and two actuators, in which the operating conditions are highly flexible, and result from the combination of the above described characteristics of the invention. Here, there may be provided as many control and monitoring electronic units as actuators, with exactly the same operation as discussed above. Alternatively, due to cost and space saving reasons, there may be provided a single control and monitoring electronic unit, for the management of all communications and all control signals set on the different control levers and on the corresponding actuators. In this case, the control stations are typically equipped with a toggle switch, which is controlled by the user to inform the electronic control and monitoring unit about the user selected control station to drive the watercraft. Hence, the electronic control and monitoring unit which receives the angular control lever displacement signal BETA from the selected control station, processes the signal as described above, and computes the displacement of the throttle controlling actuator lever ALFA by the function f(BETA).

However, if a single control and monitoring electronic unit is provided, this may provide a number of different functions f(BETA) associated to the different control levers, particularly a specific control lever may be associated to the function f(BETA) used for harbor maneuvers, whereas a different control station is associated to a function f(BETA) used for power saving navigation, as described above. Nevertheless, the various stations may be associated either to the same or different functions f(BETA), so that the watercraft may be easily and flexibly driven, to meet different user requirements.

Furthermore, in all the above cases, the electronic control and monitoring unit may be also used for the control signal transmission checking function. This allows to overcome the above mentioned prior art problems associated to a lack of the monitoring capability. According to the present invention, the electronic control and monitoring unit monitors the communication and, when a wrong signal or a lack of signal is detected in the control station, the electronic control unit brings the throttle controlling lever in the minimum opening condition, and the inverter is brought in the neutral position, while the user receives an error warning by optical and/or acoustic signals. The throttle controlling lever remains in the minimum opening condition and the inverter remains in the neutral position until the error is acknowledged by the electronic control and monitoring unit and/or the user possibly selects a different control station.

This allows to obviate the prior art problems associated, for example, to a system in which the wrong control signal is transmitted as it is to the actuator, involving a considerable danger, as a wrong maximum control lever displacement signal during a maneuver in narrow spaces leads to a number of problems, such as collisions of considerable importance, which problems are avoided by using a device according to this invention. Also, when no communication exists between the control station and the actuator, in prior art apparatuses the actuator signal is kept unchanged, which may also lead to considerable drawbacks, both during harbor maneuvers and during free navigation when other vessels, swimmers, divers or obstacles are encountered, and the lack of communication prevents any deceleration or reversing maneuvers whereas, according to this invention, no thrust is exerted on the watercraft by the engine, and the user is immediately warned thereof and has the time to take over control of the watercraft and avoids any drawback deriving from a lack of communication or a wrong communication between the control station and the actuator.

An additional characteristic of the invention is that, in some preferred embodiments, the electronic control and monitoring unit stores the sequence of detected errors. As described above, the electronic control and monitoring unit detects any control system operation errors, warns the user thereof, and in some cases takes appropriate danger preventing measures. In a preferred embodiment, the electronic control and monitoring unit also associates a code to each detected error type, and stores the rate of occurrence of the error. Hence, the electronic control and monitoring equipment may monitor any error occurring in the system and the number of occurrences of such error. The electronic control and monitoring unit may also monitor any engine and actuator malfunctions, and once more associate a code to each error and/or malfunction. All errors and malfunctions are identified as such by the electronic control and monitoring unit substantially through two preferred arrangements: according to the first arrangement, known sensors are provided to check operation and to transmit a wrong operation signal to the electronic control and monitoring unit whenever an abnormality occurs in the subsystem wherewith they are associated. In the second arrangement, the electronic control and monitoring unit generates an operation history for the control system, the engine and its parts and the actuator, and for any other system or subsystem of the watercraft which is connected to the electronic control and monitoring unit to transmit an operation signal thereto. Thus, the electronic control and monitoring unit may compare the operation signal it receives from any watercraft subsystem to identify any abnormality, i.e. any signal that excessively differs from the history of identical signals that was previously generated by the above mentioned detection. The electronic control and monitoring unit may provide not only a list of the occurrences and types of malfunctions in the control system as such, but also a list of the occurrences and types or errors and malfunctions of the watercraft part under its control. Therefore, the result of said monitoring action by the electronic control and monitoring unit may be advantageously used for maintenance purposes. This result may be displayed and/or printed and/or electronically transmitted to the user or to the watercraft maintenance personnel and/or communicated in any other manner, whereby watercraft maintenance may be well targeted, hence more effective. It will be understood, for instance, that if the electronic control and monitoring unit detects several control signal transmission errors at the remote control station, then the remote control station ought to be first checked out and possibly repaired and/or serviced. Advantages of such monitoring are apparent in terms of reduction of both times and costs for maintenance and troubleshooting. The electronic control and monitoring unit may be further used for self-checking and for providing both the complete error code and occurrence list and the suggested preventive maintenance. To this end, a list of errors and occurrences, associated to the recommended preventive maintenance, might be entered in the electronic control and monitoring unit. The electronic control and monitoring unit checks the history of system and/or subsystem and/or engine and or actuator error and/or malfunction signals and then may be able to generate, by comparison, a preventive maintenance warning, which may be useful for the user and/or the maintenance personnel for maintenance purposes.

The system of this invention may further provide a feedback to the control and monitoring electronic unit, particularly the engine speed, i.e. the number of revolutions made by the engine may be transmitted as a signal to the control unit which, in a preferred embodiment, may use such number of revolutions to appropriately set the ALFA value and/or to check for any abnormalities or errors in the system. For example, the displacement value ALFA may have to correspond to a given engine rpm value and, thanks to such feedback, the electronic control and monitoring unit might check the compliance with this value and the proper transmission of the control signal to the actuator. It may be easily understood for instance that, assuming a 10% throttle opening, the engine rpm cannot and must not be close to the maximum speed. If this occurs, there is an apparent system error, and the feedback allows to detect this error and to take the precautionary measures described above. Also, thanks to the feedback of a signal from the engine and/or the actuator, such signal may be used by the electronic control and monitoring unit and/or by the control station to check and/or monitor and/or set the above values of the table of correspondence. Therefore, the operation may be as follows: the user sets a certain engine rpm and selects, through a combination of keys, a control lever displacement corresponding to the set rpm. Therefore, the electronic control and monitoring unit uses the feedback from the engine, i.e. its rpm, which is a function of the angular displacement ALFA, and through the control lever displacement BETA, it creates a table of correspondence as selected by the user.

Regarding the linearity between the control transmitted by the control lever and the throttle opening, controlled by the actuator lever according to prior art, the corresponding diagram is shown in FIG. 5. This diagram clearly shows the linearity of this relationship and the resulting straight line: for example, an angular displacement BETA of the control lever that is 20% of the maximum displacement corresponds, in prior art, to a 20% displacement of the throttle controlling lever, and to a 20% opening of the throttle. As discussed above, this shows that an opening of the control lever that mechanically or electromechanically controls the throttle of the watercraft engine corresponds to a throttle opening, that is to a greater fuel flow to the engine. The greater fuel flow causes the engine to increase the number of its operating revolutions per minute and, as a result, its power. Nevertheless, those skilled in the art are aware that the throttle opening, causing a corresponding increase of the number of revolutions of the engine, does not linearly correspond to an increase of the power delivered by the engine, because no linear relationship exists between power and throttle opening in the equation that regulates engine operation. Particularly, their relationship is of the nonlinear type and differs from linearity especially in multiple cylinder gasoline and diesel engines.

Due to this nonlinearity, a control set on a control lever, corresponding for instance to 20% of the maximum control lever range, does not cause a proportional 20% increase of the delivered power, which may be higher or lower depending, as mentioned above, on additional parameters, such as the number of revolutions at which the throttle opens.

Conversely, according to the invention, the throttle opening and the displacement of the actuator lever that controls it is preferably nonlinear with the control BETA set on the control lever of the control station, so that the power delivered to the engine may be controlled, to such an extent as to make the delivered power linear with the control lever displacement.

For example, FIGS. 6, 7, 8 show different types of the diagram resulting from the function ALFA=f (BETA), used by the electronic control and monitoring unit 4 to mathematically relate the displacement value BETA with the displacement value ALFA. Particularly, in FIG. 6 the curve was assumed to be such that a 20% control lever displacement corresponds to a 10% increase of ALFA, therefore of the opening of the throttle controlling lever, and of the throttle itself, equal to 10% of the maximum opening. Also, a 85% displacement of BETA corresponds to a 40% ALFA. This provides a particularly accurate control in an intermediate throttle opening range, which allows the user to have a considerable control, in such a range, over the throttle opening, which is relatively small when compared with the BETA generating displacement of the control lever. Thus, the power delivered to the engine may be easily controlled all over the intermediate displacement range of the control lever, thereby allowing the user to have an accordingly accurate control over the power delivered by the engine in that range.

Nevertheless, many other arrangements may be provided for programming the function ALFA=f(BETA), that may be set on the electronic control unit, two examples whereof are shown, without limitation, in FIGS. 7, 8, 9, 10. Particularly, FIG. 7 shows such an ALFA and BETA relating function that the control set by the control lever corresponds to a displacement ALFA which depends on BETA in accordance with a curve having a convexity and a concavity. In this case, the nonlinearity of BETA with ALFA is used to obtain a user-customizable drive. The electronic control and monitoring unit may be programmed with functions f that are adapted to the different drive styles of users, providing a simple and safe drive for any user.

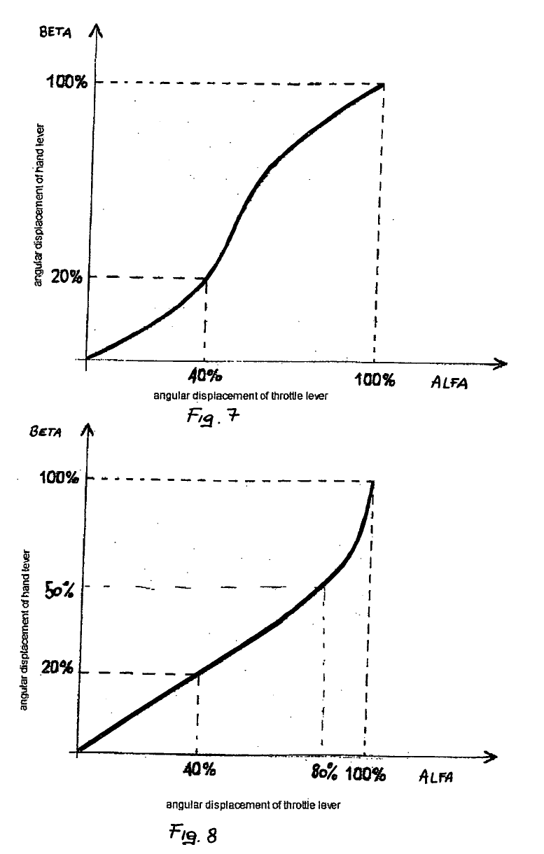

FIG. 8 shows such a mathematical dependence, or function, of ALFA on BETA, as to obtain a quasi linearity of the two displacements until a given displacement of the control lever is reached. Above a given BETA value, here shown as 50%, the throttle opening is very fast. This profile may be used, for instance, for coastwise navigation when high-speed navigation capabilities are still required.

FIG. 9 and FIG. 10 show two situations in which the maximum angular displacement of the control lever corresponds to a small throttle opening, i.e. a 50% opening in FIG. 9 and a 10% opening in FIG. 10. These two functions may be particularly useful for mooring operations or maneuvers in narrow spaces.

FIG. 12 shows a table of correspondence in which three main values are only entered and in which the omitted intermediate values are determined by the electronic control and monitoring unit by an interpolation, which may be a linear, a least-squares interpolation or any other type of interpolation, other than the ones mentioned above.

Hence, when the user moves the control lever through a given angle BETA, the displacement value is detected by the control electronic unit, which compares it with the value in the table of correspondence. If the BETA value is equal to a previously set value, the corresponding ALFA value is directly read from the table. Conversely, if the BETA value is somewhere between two different set values, without corresponding to none of them, the electronic control and monitoring unit interpolates the value in any manner to provide the interpolated ALFA value.

Moreover, according to a preferred embodiment, the above table of correspondence may be set either into a nonvolatile memory, and selected by using the DIP switches as described above, or directly through special devices in the control station during use. This allows the user the set BETA and ALFA values before, during or after operation, directly from the control station, by selecting a control configuration e.g. adapted to sea conditions, thereby making the inventive device even more flexible. Here, the control station may be associated to an input keypad through which said values may be entered.

1. An electromechanical control system for watercrafts, motorboats, ships or the like, having at least: a control station, an engine, an electromechanical actuator associated to said engine, a signal transmission device for transmitting a control signal generated by the control station to an electronic control and monitoring unit as a function of the control signal and transmitted to said electromechanical actuator for actuating the signal, and further having a signal transmission device for transmitting an actuating signal, generated by the electronic control and monitoring unit as a function of the control signal and transmitted to said electromechanical actuator for actuating the control, wherein said electronic control and monitoring unit establishes a unique correspondence between the control signal and the actuating signal by using a table of correspondence between discretized values of control signals and actuating signals and/or by determining the actuating signal value from the control signal by means of a mathematical function.

2. A system according to claim 1, wherein said control station has a control device for the user to set the control or input signal.

3. An electromechanical control system for watercrafts, motorboats, ships or the like as claimed in claim 1, wherein said control setting device is able to be displaced relative to a fixed reference, its displacement being related to a control signal value, with electric, electronic and/or electromechanical means being associated to said control device, for detecting the displacement of the control device and for generating a control signal that is uniquely related with said displacement.

4. A system as claimed in claim 1, wherein said control signal is transmitted to the electronic control and monitoring unit, through said signal transmission devices in the form of a CAN BUS.

5. A system as claimed in claim 1, wherein said actuating signal is transmitted by the electronic control and monitoring unit to said actuator, through said signal transmission devices in the form of a CAN BUS.

6. A system as claimed in claim 1, wherein said control signal setting device is a control lever which is capable of being angularly displaced (BETA) relative to a stationary reference.

7. A system as claimed in claim 1, wherein said actuator has a pivoting actuating lever which acts on the device for delivering fuel and/or fuel-air mixture of/to the engine and/or on a flow meter or control device having a flow metering or controlling member that can be angularly displaced about a predetermined axis, which lever and/or which flow meter or control device take a predetermined angular position (ALFA) relative to a stationary reference, as a function of the angular position (BETA) of the control lever relative to the corresponding stationary reference.

8. A system as claimed in claim 1, wherein said electronic control and monitoring unit is a programmable electronic unit.

9. A system as claimed in claim 1, wherein the electronic control and monitoring unit stores one or more tables of unique correlation between the control signal corresponding to the angular position (BETA) of the control lever and the actuating signal corresponding to the angular position (ALFA) of the actuating lever and/or the flow meter or control device and/or the electronic control unit stores, in the form of a program code to be executed thereby, at least one or more different functions of unique correlation between the control signal corresponding to the angular position (BETA) of the control lever and the actuating signal corresponding to the angular position (ALFA) of the actuating lever and/or the flow meter or control device, the corresponding actuating signal being determined from time to time, for each control signal, by using one of said correlation functions.

10. A system as claimed in claim 1, wherein said mathematical correspondence functions establish such a unique correspondence between said control signal and said actuating signal that ALFA=f (BETA), where BETA is the control lever displacement angle and ALFA is the opening angle of a throttle and where f is any mathematical function having BETA as a variable.

11. A system as claimed in claim 1, wherein at least one memory is associated to said electronic control unit, with means for loading in such memory one or more correlation functions f(BETA) and/or one or more tables of correspondence between the angle of the actuating lever and/or of the flow meter or control device and/or of at least one throttle (ALFA) and the angle (BETA) of a control lever.

12. A system as claimed in claim 1, wherein the control station is associated to means for selecting at least one of the different functions f(BETA) or tables of correlation between the control signal and the actuating signal, i.e. between the angle (BETA) of the control lever and the angle (ALFA) of the actuating lever and/or of the flow meter or control device and/or of at least one throttle.

13. A system as claimed in claim 12, wherein said selectors are a set of DIP switches, a certain number of combinations of switching conditions of the switches of the set being defined, and each of said combinations being uniquely related as a selection code with one of the various correlation functions f (BETA) or a different table of correspondence, and yet each switching combination of the set of DIP switches providing a control to load said correlation function or correlation table in the working storage of the control electronics.

14. A system as claimed in claim 1, wherein the correlation functions and/or the tables of correlation and the selection codes formed by the switching combinations of the set of DIP switches are stored in a nonvolatile memory.

15. A system as claimed in claim 1, wherein said electronic control unit may be programmed several times.

16. A method for controlling the throttle opening in a marine engine, wherein it includes the steps of:
setting an angular position (BETA) of a control lever;
using the value of said angular position (BETA) ad the argument of a mathematical function ALFA=f(BETA);
carrying out the mathematical computation to determine the result ALFA
displacing a lever which actuates the fuel-air mixture flow control means and/or displacing a device for metering or controlling said flow and/or opening the throttle to an extent corresponding to an angular displacement equal to the result (ALFA) as determined by the mathematical function ALFA=f(BETA).

17. A method for controlling the throttle opening in a marine engine, wherein it includes the steps of:
setting an angular position (BETA) of a control lever;
comparing the value of said angular position (BETA) with a table of correspondence between the angular position (BETA) of the control lever and the angular position (ALFA) of a lever for actuating the fuel-air mixture flow control means and/or a device for metering or controlling said flow and/or a throttle.
determining the value of the angular position (ALFA) of a lever for actuating the fuel-air mixture flow control means and/or a device for metering or controlling said flow and/or a throttle, which corresponds to the value of the angular position (BETA) of the control lever in the table of correspondence;
displacing a lever which actuates the fuel-air mixture flow control means and/or displacing a device for metering or controlling said flow and/or opening the throttle in the angular position (ALFA) as an extent corresponding to an angular displacement equal to the result (ALFA) as determined by the mathematical function ALFA=f (BETA).

18. A system as claimed in claim 1, wherein said correlation function f(BETA) is such that the power that is actually delivered by the engine is linear with the angular displacement of the control lever.

19. A system as claimed in claim 1, wherein, when maneuvering the watercraft, said correlation function f(BETA) is such that the maximum angular displacement (BETA) of the control lever corresponds to an angular position (ALFA) of a lever for actuating the fuel-air mixture flow control means and/or a device for metering or controlling said flow and/or a throttle, which is less than 100% of the maximum obtainable opening, so that the maximum power delivered by the engine is low enough as to allow safe maneuvering of the watercraft.

20. A system as claimed in claim 1, wherein a negative value of the angular displacement (BETA) corresponds to a reversal of the propeller motion by known devices.

21. A system as claimed in claim 1, wherein a positive value of the angular displacement (BETA) of the control lever is associated, by the electronic control and monitoring unit, to a first correlation function of the ALFA=f(BETA) type, and a negative value of the angular displacement (Beta) of the control lever is associated, by the electronic control and monitoring unit, to a second correlation function ALFA=f′(BETA).

22. An electromechanical system as claimed in claim 21, wherein the first correlation function f′(BETA) is identical to the second correlation function f(BETA).

23. A system as claimed in claim 21, wherein the first correlation function f(BETA) is different from the second correlation function f′(BETA).

24. An electromechanical system, particularly for marine applications, comprising at least one control station having at least one control device, e.g. one control lever, for controlling the power delivered by the engine or the number of revolutions of the engine and/or for setting the direction of rotation thereof, which control device has transducers for generating electrical control signals and which system further comprises an actuator that actuates fuel-air mixture flow control means of at least one engine, said control station and said actuator being connected by a CAN bus for transmitting the control signal from the control device to the actuator, and which system further comprises an electronic control and monitoring unit, wherein said electronic control and monitoring unit has a circuit for checking that proper communication exists between said actuator and said control station.

25. A system as claimed in claim 24, wherein it comprises an actuator for controlling navigation condition setting means, providing at least two navigation conditions, the forward and the neutral condition, whereas the electronic control unit comprises means for automatically generating the actuating signal corresponding to the minimum engine rpm setting, i.e. corresponding to a setting of the fuel-air mixture flow control means which corresponds to said minimum rpm condition, and corresponding to the neutral transmission setting, and for transmitting said signal to the actuator of the fuel-air mixture flow control means as well as the navigation condition.

26. A system as claimed in claims 24, wherein acoustic and/or visual means are provided for signaling an error condition, which means are controlled by the electronic control unit and are actuated thereby when said control unit detects an error in the communication between said control station and said actuator.

27. A system as claimed in claim 25, wherein the engine power control lever remains in the minimum opening condition and the inverter remains in the neutral position until the error is acknowledged by the electronic control and monitoring unit and/or the user possibly selects a different control station.

28. A system comprising, in combination therewith, an electronic control and monitoring unit as claimed in claim 25.

29. A system as claimed in claim 1, wherein two, three or more control stations are provided.

30. A system as claimed in claim 29, wherein said control stations are connected in series by CAN buses.

31. An electromechanical system as claimed in claim 30, wherein said control stations have toggle means for selecting/unselecting the operating control station, whose toggle signal is transmitted to said electronic control unit and allow said electronic control unit to identify the user selected station.

32. A system as claimed in claim 31, wherein the control signal processed by said electronic control unit is the control signal that corresponds to the angular displacement (BETA) of the control lever of the station selected by the toggle means.

33. A system as claimed in claim 32, wherein control stations with two or more control levers are provided.

34. A system as claimed in claim 33, wherein each control lever of each control station is connected to an engine power controlling actuator, which is connected thereto by a CAN bus.

35. A system as claimed in claim 1, wherein it may have a single electronic control and monitoring unit, associated to two or more control stations, each having one, two or more control levers, said electronic control and monitoring unit being designed and programmed in such a manner that several correlation functions f(BETA) and f′(BETA) may be provided for determining the angular position (ALFA) of an actuating lever and/or a device for metering or controlling the fuel-air mixture flow to the engine, i.e. the throttle of a throttle valve depending on the angular position (BETA) of the different control levers.

36. A system as claimed in claim 1, wherein only certain angular control lever displacement values (BETA) and certain angular positions (ALFA) of a lever for actuating the fuel-air mixture flow control means and/or a device for metering or controlling said flow and/or a throttle are entered in the table of correspondence, the intermediate values between said set values being determined by the electronic control and monitoring unit by an interpolation between said set values, which interpolation may be a linear, a least-squares interpolation or any other type of interpolation, other than the ones mentioned above.

37. A system as claimed in claim 1, wherein the control station is associated to an input means for setting the values of angular displacement (BETA) of the control lever, such as a keypad and/or a sequence of buttons and/or levers, the values of the table of correspondence being set on said input means.

38. A system as claimed in claim 1, wherein a feedback is provided to the electronic control and monitoring unit.

39. A system as claimed in claim 1, wherein said feedback to the electronic control and monitoring unit is a feedback that depends on such parameters as the engine rpm, i.e. the number of operating revolutions per minute of the engine.

40. A system as claimed in claim 1, wherein said feedback is used by the electronic control and monitoring unit to check that the signal is transmitted properly.

41. A system as claimed in claim 1, wherein said engine rpm feedback signal is used by the electronic control and monitoring unit to generate a table of correspondence by associating the number of revolutions corresponding to a predetermined displacement ALFA with an angular displacement BETA set by the user by means of the control lever.

42. A method for generating a table of correspondence in an electronic control and monitoring unit as claimed in claim 1, wherein it includes the steps of:
a—setting a desired engine rpm corresponding to an angular displacement BETA of the control lever;
b—selecting a so-called programming mode, by pushing one or more buttons on the control station;
c—discontinuing the control lever signal, so that the lever may pivot freely without transmitting any control signal to the actuator;
d—setting a preferred angular displacement BETA of the control lever;
e—reading from the feedback the engine rpm and/or the angular displacement (ALFA) of the actuating lever that corresponds to the selected angular displacement (BETA);
f—generating a table of correspondence which uniquely relates the angular displacement of the control lever (BETA) to the engine rpm and/or the angular displacement of the actuator lever (ALFA) selected during the “programming” mode;
g—repeating the steps a, c, d, e, g, if required,
f—saving the table of correspondence so obtained;
h—selecting the return to the normal mode of the system.

43. A system as claimed in claim 1, wherein said electronic control and monitoring unit has means for detecting and coding errors and means for storing error code/s and rate/s of occurrence of the corresponding error/s and/or means for comparing said error code/s and rate/s of occurrence of the corresponding error/s with a preset table.

44. A system as claimed in claim 1, wherein said electronic control and monitoring unit associates a code to any detected error type, and stores the rate of occurrence of the coded error.

45. A system as claimed in claim 1, wherein operation sensors are associated to selected watercraft subsystems, such as preferably the engine and/or the actuator and/or other subsystems, for detecting proper operation and/or subsystem operation parameter/s.

46. A system as claimed in claim 1, wherein the electronic control and monitoring unit receives input signals from said operation sensors and assigns a code to each error and monitors the rate of occurrence thereof.

47. A system as claimed in claim 1, wherein the electronic control and monitoring unit stores the time curve of the operation parameters transmitted by the sensors that detect the operation of the subsystems wherewith they are associated.

48. A system as claimed in claim 1, wherein the electronic control and monitoring unit compares the actual operation parameter curve with the stored curve, and stores any detected abnormality, i.e. any excessive difference of the detected parameters from the stored average of identical parameters.

49. A system as claimed in claim 1, wherein the electronic control and monitoring unit provides a list of the detected malfunctions and/or errors.

50. A system as claimed in claim 1, wherein the electronic control and monitoring unit compares the list of the detected errors and/or malfunctions with a stored list and provides a list of maintenance actions to be taken by the user.

51. A system as claimed in claim 1, wherein the electronic control and monitoring unit informs the user about the rate of occurrence and type of the detected errors and/malfunctions, by using special codes.

52. A system as claimed in claim 1, wherein, in lieu of control and/or actuating levers and/or of flow meter or control devices or of a throttle of a throttle valve, control and/or actuating and/or meter devices are provided which perform linear strokes instead of pivotal motions or combinations of linear and curved strokes, there being provided at least one table or at least one function of unique correlation between a signal corresponding to the stroke of the control device and the actuating signal that determines the uniquely correlated displacement of the actuator and/or the device for metering and/or controlling the fuel-air mixture flow to the engine.
